(19) United States
(12) Patent Application Publication
(10) Pub. No.: US 2015/0277764 A1
(43) Pub. Date: Oct. 1, 2015

(54) MULTI-MODE NAND-CACHING POLICY FOR HYBRID-HDD

(71) Applicant: KABUSHIKI KAISHA TOSHIBA, Tokyo (JP)

(72) Inventors: Richard M. EHRLICH, Saratoga, CA (US); Eric R. DUNN, Cupertino, CA (US)

(73) Assignee: KABUSHIKI KAISHA TOSHIBA, Tokyo (JP)

(21) Appl. No.: 14/229,660

(22) Filed: Mar. 28, 2014

(51) Int. Cl. G06F 3/06; G06F 12/08

(52) U.S. Cl. CPC G06F 3/061; G06F 3/0616; G06F 3/0659; G06F 3/0634; G06F 3/0685; G06F 3/065; G06F 12/0822

(57) ABSTRACT

A hybrid drive that includes a magnetic storage medium and a non-volatile solid-state device is operable in multiple modes and is configured to switch operation between the multiple modes, depending on the history of data accesses from a host.

### BACKGROUND

Hybrid hard disk drives (HDDs) include one or more rotating magnetic disks combined with non-volatile solid-state (e.g., flash) memory. Generally, a hybrid HDD has both the capacity of a conventional HDD and the ability to access data as quickly as a solid-state drive, and for this reason hybrid drives are well-suited for use in laptop computers. For example, non-volatile solid-state memory in a hybrid drive may be employed as a very large cache for the hybrid drive, so that data in the hybrid drive that are the most frequently and/or the most recently accessed can be retrieved from the drive without the latency associated with accessing the magnetic disks. Various caching policies are known for employing non-volatile solid-state memory in a hybrid drive as a cache, each with advantages and disadvantages.

One caching policy for a hybrid drive involves storing substantially all write data sent from a host to the non-volatile solid-state memory of the drive and copying substantially all data read from the magnetic storage device to the non-volatile solid-state memory of the drive. Thus, essentially all data recently accessed by the host in some way is cached in the non-volatile solid-state memory of the drive. Such a caching policy typically results in high performance for the hybrid drive when the span of all or most of the data accessed by a user can be stored in the non-volatile solid-state memory of the drive, that is, when a user has a small “footprint.”

Another caching policy for a hybrid drive involves storing in cache only an initial portion of any sequential read stream or write stream received from a host. For example, the first 2 megabytes (MB) of each sequential read stream and the first 1 MB of each sequential write stream received from a host may be stored in the non-volatile solid-state memory of the drive, while the remainder of sequential read or write streams is stored on the magnetic disks of the drive. Such a caching policy typically results in lower performance when a user has a small footprint relative to the previously described “cache everything” caching policy; only a portion of the data recently accessed by a host is stored in the non-volatile solid-state memory of the drive, resulting in more frequent magnetic disk accesses. However, such a caching policy generally has improved performance relative to the cache everything caching policy when the span of the data frequently accessed by the user significantly exceeds the storage capacity of the non-volatile solid-state memory of the drive. This is because attempting to store all read and write streams from a host when a user has a large footprint relative to the cache size results in “churn,” in which the contents of the cache are generally replaced with recently accessed data before they are used to satisfy a cache hit. Churning the cache contributes significantly to wear of the non-volatile solid-state memory of the drive without significantly improving drive performance.

### SUMMARY

One or more embodiments provide systems and methods for a multi-mode caching policy in a hybrid drive that includes a magnetic storage medium and a non-volatile solid-state device. The hybrid drive is operable in multiple modes and is configured to switch operation between the multiple modes, depending on the history of data accesses from a host.

A data storage device, according to embodiments, comprises a magnetic storage medium, a non-volatile solid-state device, and a controller. In one embodiment, the controller is operable in a first mode and a second mode and is configured to switch operation from the first mode to the second mode when a cache hit rate is detected to be below a predetermined threshold.

Further embodiments provide a method of operating, in at least one of two modes of operation, a storage device having a magnetic storage device and a non-volatile solid-state device that includes a cache for the data storage device. The method comprises the steps of receiving a command for accessing the storage device from a host, and executing the command in accordance with a set mode of operation. A first mode of operation is set if a cache hit rate is detected to be below a first predetermined threshold and a second mode of operation is set if the cache hit rate is detected to be above a second predetermined threshold.

### BRIEF DESCRIPTION OF THE DRAWINGS

FIG. 1 is a schematic view of an exemplary disk drive, according to one embodiment.

FIG. 2 illustrates an operational diagram of a hybrid drive with elements of electronic circuits shown configured according to one embodiment.

FIG. 3 is a schematic diagram of a data structure associated with a cache included in a flash memory device of the hybrid drive of FIG. 1, according to an embodiment.

FIG. 4 sets forth a flowchart of method steps for performing a read operation in a data storage device that includes a magnetic drive and a non-volatile solid-state drive, according to one or more embodiments.

FIG. 5 sets forth a flowchart of method steps for performing a write operation in a data storage device that includes a magnetic drive and a non-volatile solid-state drive, according to one or more embodiments.

FIG. 6 sets forth a flowchart of method steps for operating, in at least one of two modes of operation, a storage device having a magnetic storage device and a non-volatile solid-state device that includes a cache for the data storage device, according to one or more embodiments.

### DETAILED DESCRIPTION

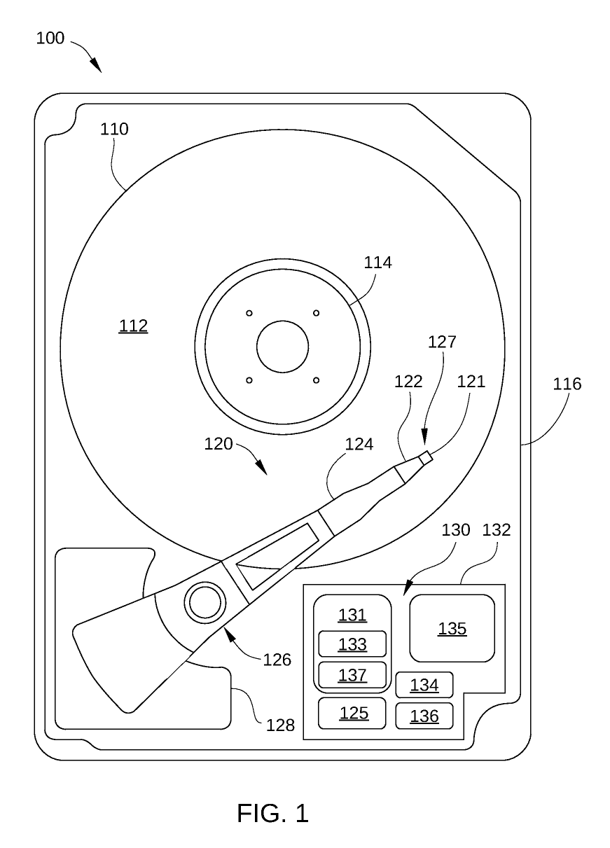

FIG. 1 is a schematic view of an exemplary disk drive, according to one embodiment. For clarity, hybrid drive 100 is illustrated without a top cover. Hybrid drive 100 includes at least one storage disk 110 that is rotated by a spindle motor 114 and includes a plurality of concentric data storage tracks. Spindle motor 114 is mounted on a base plate 116. An actuator arm assembly 120 is also mounted on base plate 116, and has a slider 121 mounted on a flexure arm 122 with a read/write head 127 that reads data from and writes data to the data storage tracks. Flexure arm 122 is attached to an actuator arm 124 that rotates about a bearing assembly 126. Voice coil motor 128 moves slider 121 relative to storage disk 110, thereby positioning read/write head 127 over the desired concentric data storage track disposed on the surface 112 of storage disk 110. Spindle motor 114, read/write head 127, and voice coil motor 128 are coupled to electronic circuits 130, which are mounted on a printed circuit board 132. Electronic circuits 130 include a read/write channel 137, a microprocessor-based controller 133, random-access memory (RAM) 134 (which may be a dynamic RAM and is used as a data buffer), and/or a flash memory device 135 and flash manager device 136. In some embodiments, flash manager device 136, read/write channel 137, and/or microprocessor-based controller 133 are included in a single chip, such as a system-on-chip 131. In some embodiments, hybrid drive 100 may further include a motor-driver chip 125, which accepts commands from microprocessor-based controller 133 and drives both spindle motor 114 and voice coil motor 128.

For clarity, hybrid drive 100 is illustrated with a single storage disk 110 and a single actuator arm assembly 120. Hybrid drive 100 may also include multiple storage disks and multiple actuator arm assemblies. In addition, each side of storage disk 110 may have an associated read/write head coupled to a flexure arm.

When data are transferred to or from storage disk 110, actuator arm assembly 120 sweeps an arc between an inner diameter (ID) and an outer diameter (OD) of storage disk 110. Actuator arm assembly 120 accelerates in one angular direction when current is passed in one direction through the voice coil of voice coil motor 128 and accelerates in an opposite direction when the current is reversed, thereby allowing control of the position of actuator arm assembly 120 and attached read/write head 127 with respect to storage disk 110. Voice coil motor 128 is coupled with a servo system known in the art that uses the positioning data read from servo wedges on storage disk 110 by read/write head 127 to determine the position of read/write head 127 over a specific data storage track. The servo system determines an appropriate current to drive through the voice coil of voice coil motor 128, and drives said current using a current driver and associated circuitry.

Hybrid drive 100 is configured as a hybrid drive, and in normal operation data can be stored to and retrieved from storage disk 110 and/or flash memory device 135. In a hybrid drive, non-volatile memory, such as flash memory device 135, supplements the spinning storage disk 110 to provide faster boot, hibernate, resume and other data read-write operations, as well as lower power consumption. To that end, a major portion of flash memory device 135 may be configured as a cache for hybrid drive 100, storing data that are the most frequently and/or the most recently accessed by a host, even when such data are also stored on storage disk 110. Such a hybrid drive configuration is particularly advantageous for battery-operated computer systems, such as mobile computers or other mobile computing devices. In a preferred embodiment, flash memory device is a non-volatile solid state storage medium, such as a NAND flash chip that can be electrically erased and reprogrammed, and is sized to supplement storage disk 110 in hybrid drive 100 as a non-volatile storage medium. For example, in some embodiments, flash memory device 135 has data storage capacity that is orders of magnitude larger than RAM 134, e.g., gigabytes (GB) vs. megabytes (MB).

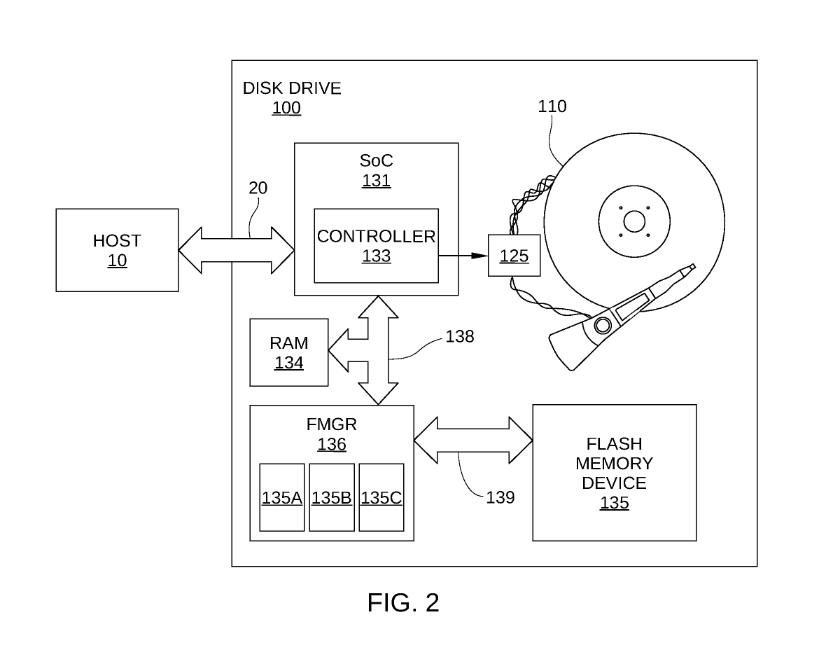

FIG. 2 illustrates an operational diagram of hybrid drive 100 with elements of electronic circuits 130 shown configured according to one embodiment. As shown, hybrid drive 100 includes RAM 134, flash memory device 135, a flash manager device 136, system-on-chip 131, and a high-speed data path 138. Hybrid drive 100 is connected to a host 10, such as a host computer, via a host interface 20, such as a serial advanced technology attachment (SATA) bus.

In the embodiment illustrated in FIG. 2, flash manager device 136 controls interfacing of flash memory device 135 with high-speed data path 138 and is connected to flash memory device 135 via a NAND interface bus 139. System-on-chip 131 includes microprocessor-based controller 133 and other hardware (including read/write channel 137) for controlling operation of hybrid drive 100, and is connected to RAM 134 and flash manager device 136 via high-speed data path 138. In alternative embodiments, flash manage device 135 may be formed as part of system-on-chip 131. Microprocessor-based controller 133 is a control unit that may include a microcontroller such as an ARM microprocessor, a hybrid drive controller, and any control circuitry within hybrid drive 100. High-speed data path 138 is a high-speed bus known in the art, such as a double data rate (DDR) bus, a DDR2 bus, a DDR3 bus, or the like.

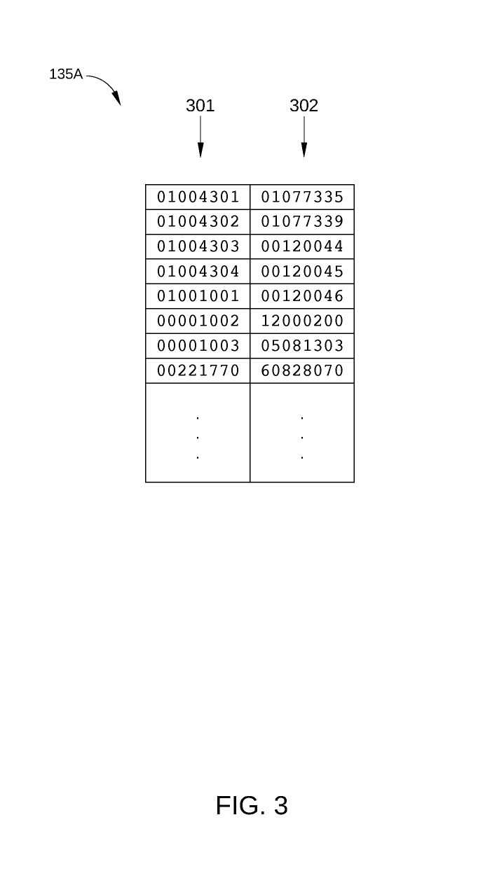

As noted above, some or most of flash memory device 135 may be configured as a cache for hybrid drive 100, storing data in hybrid drive 100 that are the most frequently and/or the most recently accessed by host 10. Such data are generally the most likely data to be requested again by host 10, and, being stored in flash memory device 135, can be provided to host 10 much more quickly and with less energy expenditure than data that are retrieved from storage disk 110. When flash memory device 135 is configured as a cache for hybrid drive 100, hybrid drive 100 includes a data structure 135A that maps logical block addresses (LBAs) stored in flash memory device 135 (i.e., LBAs most recently and/or most frequently accessed by host 10) to physical locations (i.e., memory blocks) in flash memory device 135. In the embodiment illustrated in FIG. 2, data structure 135A is included in flash manager device 136, but in other embodiments, data structure 135A may be configured as part of a different component of hybrid drive 100, such as controller 133 or flash memory device 135 itself. One embodiment of data structure 135A is illustrated in FIG. 3.

FIG. 3 is a schematic diagram of data structure 135A associated with a cache included in flash memory device 135, according to an embodiment. Data structure 135A is a data structure, such as an associative array or map, that maps each of cache entries 301 stored in flash memory device 135 to a particular physical location 302 in flash memory device 135 at which the cache entry is stored. Each of cache entries 301 includes one or more LBAs that are stored in flash memory device 135 as cache to reduce or eliminate accesses to storage disk 110, thereby improving performance and reducing energy use of hybrid drive 100. In the embodiment illustrated in FIG. 3, each cache entry (which may correspond to a single 512-byte sector) is mapped to a physical location 302. In other embodiments, a single cache entry 301 may correspond to a much larger space, such as 64 512-byte sectors (i.e., a 32 kB space). In such embodiments, each cache entry 301 may have a resolution of 4 kB, and so can account for the status of eight 4 kB blocks. Thus, each cache entry 301 may have a starting address (in units of 4 kB blocks) and a “valid” bit for each of the eight 4 kB blocks. Still other configurations of data structure 135A may be employed without exceeding the scope of the disclosure.

In some embodiments, an eviction scheme is employed by microprocessor-based controller 133 or flash manager device 136 in conjunction with the operation of data structure 135A. The eviction scheme facilitates the systematic removal of data from flash memory device 135, so that data that are the least recently used (LRU), the least frequently used (LFU), or a combination of both are evicted from data structure 135A and associated data are removed from flash memory device 135. In this way, data previously accessed by host 10 in hybrid drive 100 that are the most likely to be accessed again by host 10 are in cache, and data less likely to be accessed again by host 10 are removed from cache. In such embodiments, an additional data structure 135B may be included in either microprocessor-based controller 133, flash manager device 136, or flash memory device 135. Additional data structure 135B is configured to track the frequency of use of cache entries 301, the recency of use of cache entries 301, and/or a combination of both. For example, additional data structure 135B may include a double-linked list for tracking relative recency of each of cache entries 301 and a double-linked list for tracking relative frequency of each of cache entries 301. In some embodiments, data structure 135A and additional structure 135B are combined as a single data structure.

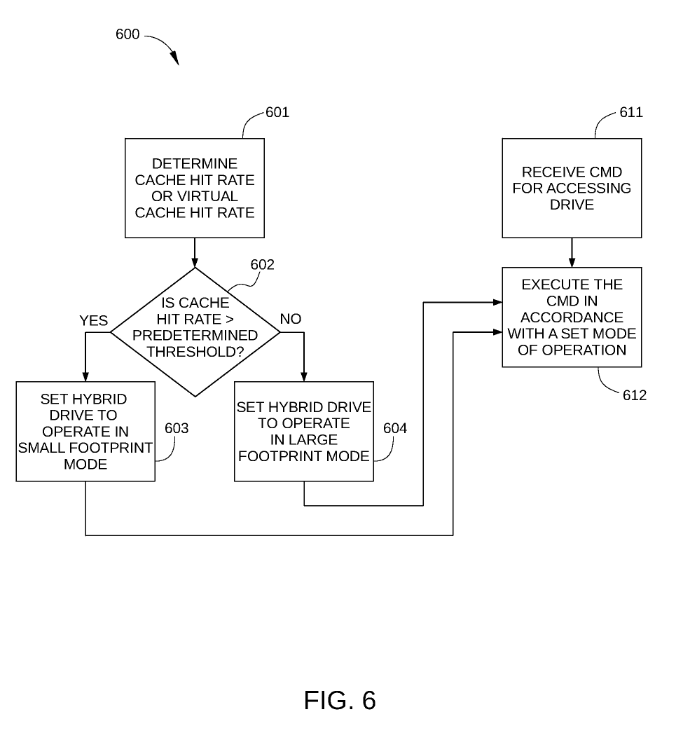

In some embodiments, a ghost data structure 135C may be included in either microprocessor-based controller 133, flash manager device 136, or flash memory device 135. Ghost data structure 135C is configured to track, while hybrid drive 100 operates in a large footprint mode, the frequency and/or recency of use of virtual cache entries via a procedure described below in conjunction with FIG. 6. Consequently, ghost data structure 135C has substantially the same size and configuration as data structure 135A. However, rather than mapping LBAs (and associated data) stored in flash memory device 135 to physical locations in flash memory device 135, ghost data structure 135C maps LBAs to virtual locations in flash memory device 135. Such a mapping may be based on what physical locations would have been occupied by data associated with the mapped LBAs if hybrid drive 100 were operating in small footprint mode. Thus, as read and write commands are received from host 10, the LBAs associated with these read and write commands are entered as cache entries in ghost data structure 135C, and are evicted according to a suitable eviction scheme when additional space in ghost data structure 135C is needed to allow additional cache entries to be made.

According to some embodiments, micro-processor controller 133 is operable in multiple modes and is configured to switch operation between the multiple modes, depending on the history of data accesses from host 10. For example, when the span of all or most of the data accessed by host 10 can be stored in the cache in flash memory device 135, micro-processor controller 133 determines a host has a small footprint with respect to the cache in flash memory device 135, and is configured to operate in a first mode. Conversely, when the span of the data frequently or recently accessed by host 10 significantly exceeds the size of the cache in flash memory device 135, micro-processor controller 133 determines host 10 has a large footprint with respect to the cache in flash memory device 135, and is configured to operate in a second mode. Thus, micro-processor controller 133 operates in a different mode depending on the size of the host footprint relative to the size of the cache in flash memory device 135.

In some embodiments, a mode of operation associated with a host having a small footprint may include storing in cache (i.e., in flash memory device 135) substantially all data associated with LBAs included in write commands from host 10, as well as entering said LBAs into data structure 135A and/or into additional data structure 135B. In addition, this mode of operation may include storing in cache substantially all data read from storage disk 110 in response to a read command from host 10. Such a mode of operation generally facilitates high performance when most or substantially all of the data accessed by host 10 can be stored in cache. In another example of a small footprint mode for host 10, larger stream limits N and M (described below for large footprint mode) are defined relative to the stream limits N and M of the large footprint mode.

In some embodiments, a mode of operation associated with a large footprint may include writing an initial portion of each sequential write stream received from host 10 to cache. For example, the initial M MB (for example 1 MB, 5 MB, etc.) of each sequential write stream may be written to cache and the remainder of the write stream may be written to disk. In addition, this mode of operation may further include writing data associated with an initial portion of each sequential read stream received from host 10 to cache. For example, the initial N MB (for example 5 MB, 10 MB, etc.) of data associated with the LBAs of each sequential read stream may be written to cache, except for data associated with LBAs that are already stored in cache (i.e., in flash memory device 135). Such a mode of operation generally facilitates improved performance relative to other modes of operation when host 10 has a large footprint relative to cache. In other embodiments, any other technically feasible mode of operation for hybrid drive 100 may be associated with a large footprint for host 10. For example, while operating in a large footprint mode, hybrid drive 100 may be configured to store in flash memory device 135 write data in a write command received from host 10 that are associated with LBAs that overlap with LBAs for which data associated therewith are already stored in flash memory device 135.

In some embodiments, N=M, so that the initial portion of each sequential read stream written to cache is substantially equal to the initial portion of each sequential write stream written to cache. In other embodiments, N>M, so that a larger portion of each sequential read stream is written to cache than of each sequential write steam. It is noted that cache misses in read operations can significantly impact performance, since an access to storage disk 110 generally results from such a cache miss in hybrid drive 100. Consequently, embodiments in which N>M tend to increase the portion of cache that is used for storing read streams, which generally reduces the likelihood of cache misses in future read operations.

In some embodiments, micro-processor controller 133 may be operable in additional modes of operation than the small footprint and large footprint modes of operation described above. For example, micro-processor controller 133 may be operable in one or more intermediate modes that are different combinations of the above-described modes, where the one or more intermediate modes are selected based on an estimated host footprint size. In some such embodiments, the values of M and N may not be fixed. For example, when host 10 is determined to have a small footprint, hybrid drive 100 may be placed in a mode of operation in which an initial portion of each sequential write stream is written to cache and an initial portion of each sequential read stream is written to cache, where the values of M and N may vary as a function of the size of the footprint of host 10.

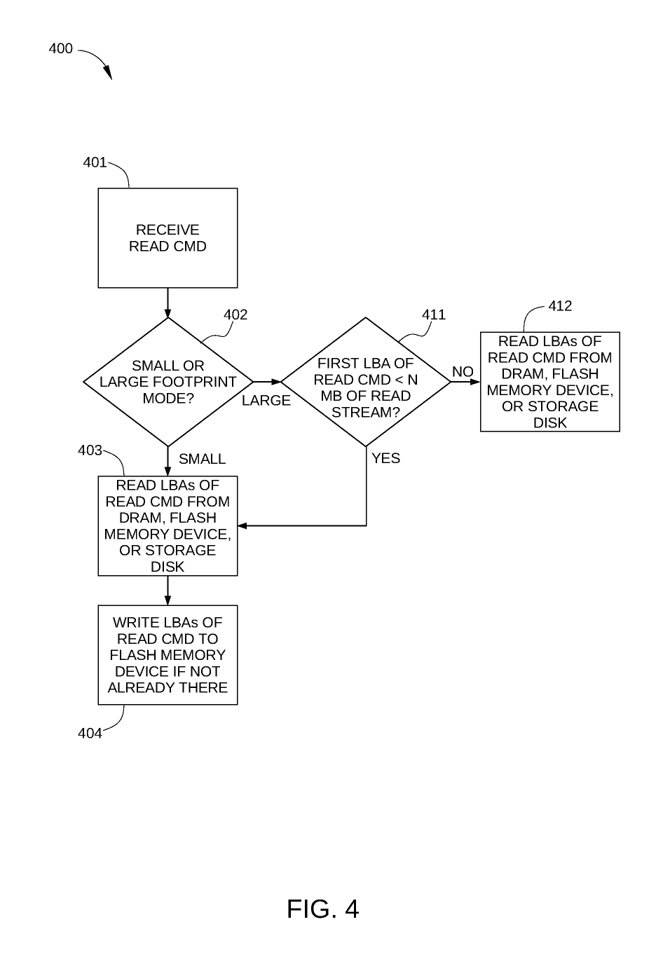

FIG. 4 sets forth a flowchart of method steps for performing a read operation in a data storage device, such as hybrid drive 100, that includes a magnetic drive and a non-volatile solid-state drive, according to one or more embodiments. Although the method steps are described in conjunction with hybrid drive 100 in FIGS. 1-3, persons skilled in the art will understand the method steps may be performed with other types of systems. While described below as performed by microprocessor-based controller 133, control algorithms for the method steps may reside in and/or be performed by microprocessor-based controller 133, flash manager device 136, or any other suitable control circuit or system associated with hybrid drive 100.

As shown, a method 400 begins at step 401, where microprocessor-based controller 133 receives a read command from host 10. The read command so received may be the beginning of a sequential read stream (i.e., a read stream in which the read commands making up the read stream form a group of sequential LBAs), or a later portion of a sequential read stream. In some embodiments, microprocessor-based controller 133 receives the read command into RAM 134.

In step 402, microprocessor-based controller 133 checks in which mode hybrid drive 100 is currently operating. When microprocessor-based controller 133 determines hybrid drive 100 is currently operating in small footprint mode, method 400 proceeds to step 403. When microprocessor-based controller 133 determines hybrid drive 100 is currently operating in large footprint mode, method 400 proceeds to step 411.

In some embodiments, the determination in step 402 is made based on a cache hit rate, where the cache hit rate is based on the portion of the total number of read commands and write commands received from host 10 that correspond to cache hits in the cache. When a cache hit rate falls below, for example, 95%, hybrid drive 100 is switched to large footprint operation. In some embodiments, the cache hit rate may be calculated as 1 minus the fraction of read and/or write commands received from host 10 that result in a “cache miss” (when at least some of the data associated with a read and/or write command is not stored in flash memory device 135 and therefore results in an access to storage disk 110). In such embodiments, such a fraction of read and/or write commands may be based on read and/or write commands received from host 10 over a predetermined time period. In other embodiments, the cache hit rate is based on the portion of the total quantity of data associated with read commands and write commands received from host 10 that correspond to cache hits in the cache. For example, in some embodiments, the cache hit rate may be calculated as 1 minus the fraction of the total quantity of data associated with read and/or write commands received from host 10 that corresponds to cache misses.

In embodiments in which a cache hit rate as described above is employed, host 10 may be determined to have a small footprint when the cache hit rate is equal to or greater than a predetermined threshold. Conversely, host 10 may be determined to have a large footprint when the cache hit rate is less than the predetermined threshold. Furthermore, in some embodiments, the predetermined threshold may be altered under certain circumstances, such as when significant wear has been experienced by flash memory device 135. In such embodiments, the predetermined threshold may be increased, so that host 10 may be considered to have a small footprint when all or substantially all data accessed by host 10 can be stored in flash memory device. In this way, wear can be slowed on flash memory device 135 by expanding the operating conditions under which large footprint mode is used. Generally, the determination of what footprint size host 10 currently has with respect to hybrid drive 100 is typically performed prior to method 400.

In the embodiment illustrated in FIG. 4, hybrid drive 100 is configured to operate in one of two modes: small footprint mode, in which the span of all or most data accessed by host 10 over a particular time period is smaller than the portion of flash memory device 135 reserved for cache, and large footprint mode, in which the span of all or most data accessed by host 10 over a particular time period is larger than the portion of flash memory device 135 reserved for cache. In other embodiments, hybrid drive 100 may be configured to operate in additional modes of operation, such as intermediate modes between small footprint mode and large footprint mode.

In step 403, microprocessor-based controller 133 causes the data associated with the LBAs included in the read command received in step 401 to be read and provides this data to host 10. Said data may be located in RAM 134 (such as when these LBAs have been recently accessed by host 10), in the cache disposed in flash memory device 135, and/or on storage disk 110. In some embodiments, microprocessor-based controller 133 may first check RAM 134 for the LBAs included in the read command, then check flash memory device 135 (for example via data structure 135A), then finally check storage disk 110. In some embodiments, microprocessor-based controller 133 also updates additional data structure 135B to reflect the changed recency and/or frequency of accesses by host 10 to the LBAs included in the read command.

In step 404, microprocessor-based controller 133 causes the LBAs read in step 403 to be written to the cache disposed in flash memory device 135. In some embodiments, any LBAs read in step 403 from flash memory device 135 are not written to cache in step 404, since these LBAs are already stored in flash memory device 135.

In step 411, microprocessor-based controller 133 determines whether the first LBA of the read command received in step 401 corresponds to data that is within an initial portion of the data associated with a sequential read stream, where the initial portion of the data associated with the sequential read stream has a predetermined size. For example, the initial portion of the data associated with the sequential read stream may have a predetermined size of N, where N=1 MB, 5 MB, 10 MB, etc. Thus, if the first LBA of the read command received in step 401 includes data that are within the initial N MB of data associated with a sequential read stream currently being received from host 10, method 400 proceeds to step 403. If microprocessor-based controller 133 determines that the first LBA of the read command received in step 401 is associated with no data that are within the initial N MB of the data associated with the sequential read stream currently being received from host 10, method 400 proceeds to step 412. In other embodiments, in step 411 microprocessor-based controller 133 may determine whether any other particular LBA of the read command received in step 401 is associated with data that is within an initial portion of a sequential read stream, such as the last LBA, the middle LBA, or any other LBA included in the read command. In still other embodiments, in step 411 microprocessor-based controller 133 may determine whether all LBAs of the read command received in step 401 is associated with data that is within an initial portion of a sequential read stream.

In step 412, microprocessor-based controller 133 causes the data associated with LBAs included in the read command received in step 401 to be read and provides this data to host 10. Embodiments similar to those described in step 403 may be implemented in step 412.

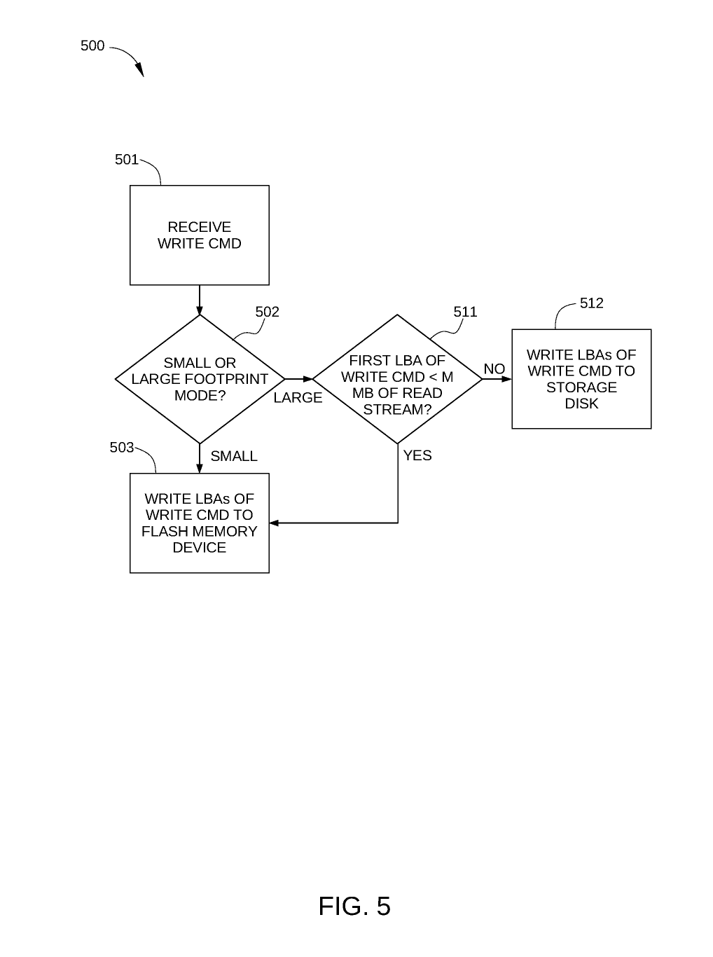

FIG. 5 sets forth a flowchart of method steps for performing a write operation in a data storage device, such as hybrid drive 100, that includes a magnetic drive and a non-volatile solid-state drive, according to one or more embodiments. Although the method steps are described in conjunction with hybrid drive 100 in FIGS. 1-3, persons skilled in the art will understand the method steps may be performed with other types of systems. While described below as performed by microprocessor-based controller 133, control algorithms for the method steps may reside in and/or be performed by microprocessor-based controller 133, flash manager device 136, or any other suitable control circuit or system associated with hybrid drive 100.

As shown, a method 500 begins at step 501, where microprocessor-based controller 133 receives a write command from host 10, the write command including LBAs and data corresponding to these LBAs to be stored in hybrid drive 100. The write command so received may be the beginning of a sequential write stream (i.e., a write stream in which the write commands making up the write stream form a group of sequential LBAs), or a later portion of a sequential write stream. In some embodiments, microprocessor-based controller 133 receives the write command into RAM 134.

In step 502, microprocessor-based controller 133 checks in which mode hybrid drive 100 is currently operating. When microprocessor-based controller 133 determines hybrid drive 100 is currently operating in small footprint mode, method 500 proceeds to step 503. When microprocessor-based controller 133 determines hybrid drive 100 is currently operating in large footprint mode, method 500 proceeds to step 511. Embodiments similar to those described in step 402 of method 400 may be implemented prior to method 500 for determining what footprint size host 10 currently has with respect to hybrid drive 100.

In the embodiment illustrated in FIG. 5, hybrid drive 100 is configured to operate in one of two modes: small footprint mode and large footprint mode. In other embodiments, hybrid drive 100 may be configured to operate in additional modes of operation, such as intermediate modes between small footprint mode and large footprint mode.

In step 503, microprocessor-based controller 133 causes the LBAs included in the write command received in step 501 to be written to flash memory device 135. In some embodiments, microprocessor-based controller 133 also updates additional data structure 135B to reflect the changed recency and/or frequency of accesses by host 10 to the LBAs included in the write command. In some embodiments, an eviction and/or garbage collection procedure may also be performed in flash memory device 135 prior to writing the LBAs included in the write command received in step 501 to flash memory device 135.

In step 511, microprocessor-based controller 133 determines whether the first LBA, or in some embodiments all LBAs, of the write command received in step 501 corresponds to data that is within an initial portion of a sequential write stream currently being received from host 10 and includes the received write command, where the initial portion of the sequential write stream has a predetermined size. For example, the initial portion of the sequential write stream may have a predetermined size of M, where M=0.5 MB, 1 MB, 2 MB, etc. Thus, if the first LBA of the write command received in step 501 includes data that are within the initial M MB of a sequential write stream currently being received from host 10, method 500 proceeds to step 503. If microprocessor-based controller 133 determines that the first LBA of the write command received in step 501 is not associated with any data that are within the initial M MB of the sequential write stream currently being received from host 10, method 500 proceeds to step 512. In other embodiments, in step 511 microprocessor-based controller 133 may determine whether any other particular LBA of the write command received in step 501 corresponds to data that are within an initial portion of a sequential write stream, such as the last LBA, the middle LBA, or any other LBA of the write command.

In step 512, microprocessor-based controller 133 causes data associated with the LBAs included in the write command received in step 501 to be written to storage disk 110.

FIG. 6 sets forth a flowchart of method steps for operating, in at least one of two modes of operation, a storage device having a magnetic storage device and a non-volatile solid-state device that includes a cache for the data storage device, according to one or more embodiments. Although the method steps are described in conjunction with hybrid drive 100 in FIGS. 1-3, persons skilled in the art will understand the method steps may be performed with other types of systems. While described below as performed by microprocessor-based controller 133, control algorithms for the method steps may reside in and/or be performed by microprocessor-based controller 133, flash manager device 136, or any other suitable control circuit or system associated with hybrid drive 100.

As shown, a method 600 begins at step 601, where microprocessor-based controller 133 determines either a cache hit rate or a virtual cache hit rate for flash memory device 135, depending on the current mode of operation of hybrid drive 100. Specifically, when hybrid drive 100 is in small footprint mode, a cache hit rate is determined in step 601, and when hybrid drive 100 is in large footprint mode, a virtual cache hit rate is determined in step 601.

In some embodiments, the cache hit rate may be based on the portion of the total number of read commands and write commands received from host 10 that correspond to cache hits in the cache. For example, any read or write command received from host 10 that includes only LBAs associated with data that are currently stored in flash memory device 135 (i.e., LBAs that are currently entries in data structure 135A) increments the cache hit rate. Conversely, any read or write command that includes at least one LBA associated with data that are not stored in flash memory device 135 (i.e., an LBA that is not currently an entry in data structure 135A) decrements the cache hit rate. In other embodiments, the cache hit rate may be based on the portion of the total quantity of data associated with read commands and write commands received from host 10 that correspond to cache hits in the cache.

In some embodiments, the virtual cache hit rate may be determined using a procedure similar to that used to determine the cache hit rate, described above. However, unlike the cache hit rate, the virtual cache hit rate is generally only determined when hybrid drive 100 operates in large footprint mode. Furthermore, while the cache hit rate is determined based on what LBAs and associated data are actually stored in flash memory device 135 (e.g., using data structure 135A), the virtual cache hit rate is determined based on what LBAs and associated data would be stored in flash memory device 135 if hybrid drive 100 were operating in small footprint mode (e.g., using ghost data structure 135C). Thus, in some embodiments, ghost data structure 135C may be employed to determine what LBAs included in a read or write command would constitute a virtual cache hit or a virtual cache miss.

In step 602, microprocessor-based controller 133 determines if the cache hit rate (or virtual cache hit rate) calculated in step 601 is greater than a predetermined threshold, e.g., 90%, 95%, etc. When hybrid drive 100 is in small footprint mode, microprocessor-based controller 133 determines the cache hit rate in step 602. When hybrid drive 100 is in large footprint mode, microprocessor-based controller 133 determines the virtual cache hit rate in step 602. If the cache hit rate (or virtual cache hit rate) exceeds the predetermined threshold, method 600 proceeds to step 603. If the cache hit rate (or virtual cache hit rate) is less than the predetermined threshold, method 600 proceeds to step 604.

In some embodiments, a first and a second predetermined threshold may be employed in step 602. Specifically, a first mode of operation (e.g., small footprint mode) is set if a cache hit rate is detected to be above the first predetermined threshold and a second mode of operation (e.g., large footprint mode) is set if the cache hit rate is detected to be below a second predetermined threshold. In such embodiments, the first predetermined threshold is greater than the second predetermined threshold, so that when host 10 has a footprint that is near the switchover point between small footprint and large footprint operation, hybrid drive 100 does not switch repeatedly between the two modes of operation.

In step 603, microprocessor-based controller 133 sets hybrid drive 100 to operate in small footprint mode.

In step 604, microprocessor-based controller 133 sets hybrid drive 100 to operate in large footprint mode.

In step 611, microprocessor-based controller 133 receives a command for accessing hybrid drive 100 from host 10. The request may be a read command or a write command.

In step 612, microprocessor-based controller 133 executes the command in accordance with the currently set mode of operation, e.g., small footprint mode or large footprint mode.

In sum, embodiments described herein provide systems and methods for operating, in at least one of two modes of operation, a storage device having a magnetic storage device and a non-volatile solid-state device that includes a cache for the data storage device. The storage device is configured to switch operation between the multiple modes of operation, depending on the history of data accesses from a host. Advantageously, the storage device has good performance whether the host has a small footprint or a large footprint relative to the size of the non-volatile solid-state device.

While the foregoing is directed to embodiments of the present invention, other and further embodiments of the invention may be devised without departing from the basic scope thereof, and the scope thereof is determined by the claims that follow.

We claim:

1. A data storage device comprising:
a magnetic storage device;
a non-volatile solid-state device that includes a cache for the data storage device; and
a controller operable in a first mode and a second mode,
wherein the controller is configured to switch operation from the first mode to the second mode when a cache hit rate is detected to be below a predetermined threshold.

2. The data storage device of claim 1, wherein the controller is further configured to increase the predetermined threshold when a measure of wear associated with the non-volatile solid-state device exceeds a predetermined wear level.

3. The data storage device of claim 1, wherein the controller is further configured to calculate the cache hit rate based on a portion of the total number of read commands and write commands received from the host that correspond to cache hits in the cache.

4. The data storage device of claim 1, wherein the controller is further configured to calculate the cache hit rate based on a portion of the total quantity of data associated with read commands and write commands received from the host that correspond to cache hits in the cache.

5. The data storage device of claim 1, wherein the first mode comprises writing to the cache substantially all write data received from a host to the cache and a copy of substantially all read data requested by the host that are read from the magnetic storage device.

6. The data storage device of claim 1, wherein the second mode comprises, when a sequential write stream is received from a host, writing an initial portion of the sequential write stream to the cache, the initial portion of the sequential write stream having a first predetermined size, and, when a sequential read stream is received from the host, writing an initial portion of the sequential read stream to the cache, the initial portion of the sequential read stream having a second predetermined size.

7. The data storage device of claim 6, wherein the first predetermined size is less than the second predetermined size.

8. The data storage device of claim 1, wherein the controller is further configured to, while operating in the second mode:
maintain a virtual cache of read commands and write commands received from a host, wherein the virtual cache is substantially equal in size to the cache and is configured to store metadata associated with the most recently received read commands and write commands received from the host;
calculate a virtual cache hit rate based on cache hits to the virtual cache; and
switch operation from the second mode to the first mode when the virtual cache hit rate is detected to be above a predetermined threshold.

9. The data storage device of claim 8, wherein the controller is further configured to calculate the virtual cache hit rate based on a portion of the total number of read commands and write commands received from the host that correspond to cache hits in the virtual cache.

10. The data storage device of claim 8, wherein the controller is further configured to calculate the virtual cache hit rate based on a portion of the total quantity of data associated with read commands and write commands received from the host that correspond to cache hits in the virtual cache.

11. A method of operating, in at least one of two modes of operation, a storage device having a magnetic storage device and a non-volatile solid-state device that includes a cache for the data storage device, the method comprising:
receiving a command for accessing the storage device from a host; and
executing the command in accordance with a set mode of operation,
wherein a first mode of operation is set if a cache hit rate is detected to be below a first predetermined threshold and a second mode of operation is set if the cache hit rate is detected to be above a second predetermined threshold.

12. The method of claim 11, wherein the first predetermined threshold is less than the second predetermined threshold.

13. The method of claim 11, further comprising increasing the first predetermined threshold when a measure of wear associated with the non-volatile solid-state device exceeds a predetermined wear level.

14. The method of claim 11, further comprising calculating the cache hit rate based on a portion of the total number of read commands and write commands received from the host that correspond to cache hits in the cache.

15. The method of claim 11, further comprising calculating the cache hit rate based on a portion of the total quantity of data associated with read commands and write commands received from the host that correspond to cache hits in the cache.

16. The method of claim 11, wherein the first mode comprises writing to the cache substantially all write data received from a host to the cache and a copy of substantially all read data requested by the host that are read from the magnetic storage device.

17. The method of claim 11, wherein the second mode comprises, when a sequential write stream is received from a host, writing an initial portion of the sequential write stream to the cache, the initial portion of the sequential write stream having a first predetermined size, and, when a sequential read stream is received from the host, writing an initial portion of the sequential read stream to the cache, the initial portion of the sequential read stream having a second predetermined size.

18. The method of claim 11, further comprising, while operating in the second mode:
maintaining a virtual cache of read commands and write commands received from a host, wherein the virtual cache is substantially equal in size to the cache and is configured to store metadata associated with the most recently received read commands and write commands received from the host;
calculating a virtual cache hit rate based on cache hits to the virtual cache; and
switching operation from the second mode to the first mode when the virtual cache hit rate is detected to be above a predetermined threshold.

19. The method of claim 18, further comprising calculating the virtual cache hit rate based on a portion of the total number of read commands and write commands received from the host that correspond to cache hits in the virtual cache.

20. The method of claim 18, further comprising calculating the virtual cache hit rate based on a portion of the total quantity of data associated with read commands and write commands received from the host that correspond to cache hits in the virtual cache.
